(19) United States
(12) Patent Application Publication
(10) Pub. No.: US 2009/0069066 A1
(43) Pub. Date: Mar. 12, 2009

(54) Slot Machine Having A Transparent Liquid Crystal Display

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/204,427

(22) Filed: Sep. 4, 2008

(30) Foreign Application Priority Data
Sep. 6, 2007 (JP) JP2007-231398

(51) Int. Cl. A63F 9/24; A63F 13/00

(52) U.S. Cl. 463/20

(57) ABSTRACT

One of the symbols on each video reel V1, V2 is rearranged in each display window W1, W2 on a first display screen G1, respectively. One of the symbols on each video reel V3, V4 is rearranged in each display window W3, W4 on a second display screen G2. One of the symbols on a mechanical reel R is rearranged in a display window TW1 which is in a transparent state on the first display screen G1 and a display window TW2 which is in a transparent state on the second display screen G2 respectively, through the rotation and the stop of the mechanical reel R. Accordingly, there are executed simultaneously a slot game using each of the display windows W1, TW1, W2 on the first display screen G1 and a slot game using each of the display windows W3, TW2, W4 on the second display screen G2.

### CROSS-REFERENCE TO RELATED APPLICATIONS

This application is based upon and claims a priority from the prior Japanese Patent Application No. 2007-231398 filed on Sep. 6, 2007, the entire contents of which are incorporated herein by reference.

### BACKGROUND

1. Field

The present invention relates to a slot machine having a transparent liquid crystal display.

2. Description of Related Art

A conventional slot machine having a transparent liquid crystal display has also a mechanical reel that is visible to a player through the transparent liquid crystal display. Consequently, a behavior of rotating/stopping the mechanical reel is performed on the transparent liquid crystal display together with the gaming images to be displayed in conjunction with the behavior.

Additionally, as prior art document information related to the conventional slot machine having a transparent liquid crystal display, there is US 2005/0170878A1.

In the conventional control technology, however, gaming images of a transparent liquid crystal display are displayed in conjunction with a behavior of rotating/stopping one mechanical reel. Accordingly, when two independent gaming images are arranged, providing two mechanical reels corresponding to the respective gaming images has been necessary. Thus, although the two independent gaming images can be recognized as two separate games, it is still difficult for a player to recognize that they are one interlocking game.

### SUMMARY

Accordingly, the present invention has been made in light of the above, and it is an object of the invention to provide an unprecedented novel slot machine characterized by increasing entertainability in a transparent liquid crystal display.

To achieve the object of the disclosure, there is provided a slot machine, comprising: a mechanical reel for which a symbol is provided; a first display screen putting a first portion of the mechanical reel into a visible state in a transparent area, while displaying a symbol in a non-transparent area; a second display screen putting a second portion of the mechanical reel into a visible state in a transparent area, while displaying a symbol in a non-transparent area; a transparent liquid crystal display provided with the first display screen and the second display screen; and a processor controlling the mechanical reel and the transparent liquid crystal display, programmed to execute processes of: (a) rotating and stopping the mechanical reel at each unit game, while rearranging a symbol displayed at least one of the first display screen and the second display screen at each unit game; (b) identifying a first symbol combination by a symbol at the first portion of the mechanical reel in the visible state in the transparent area of the first display screen and a symbol when displayed in the non-transparent area of the first display screen; (c) identifying a second symbol combination by a symbol at the second portion of the mechanical reel in the visible state in the transparent area of the second display screen and a symbol when displayed in the non-transparent area of the second display screen; and (d) awarding a payout to a player based on one of the first symbol combination and the second symbol combination.

Furthermore, according to another aspect, there is provided a slot machine, comprising: a mechanical reel for which a symbol is provided; a first display screen putting a first portion of the mechanical reel into a visible state in a transparent area, while displaying a symbol in a non-transparent area; a second display screen putting a second portion of the mechanical reel into a visible state in a transparent area, while displaying a symbol in a non-transparent area; a transparent liquid crystal display provided with the first display screen and the second display screen; a slide mechanism moving the mechanical reel in a direction perpendicular to a rotating direction of the mechanical reel; and a processor controlling the mechanical reel, the transparent liquid crystal display and the slide mechanism, programmed to execute processes of: (a-1) making a determination on whether to move the mechanical reel or not; (a-2) when moving the mechanical reel by the determination, changing a position of the mechanical reel while shifting the transparent area and the non-transparent area of the first display screen and the second display screen in accordance with a changed position of the mechanical reel; (a-3) rotating and stopping the mechanical reel at each unit game, while rearranging a symbol displayed at least one of the first display screen and the second display screen at each unit game; (b) identifying a first symbol combination by a symbol at the first portion of the mechanical reel in the visible state in the transparent area of the first display screen and a symbol when displayed in the non-transparent area of the first display screen; (c) identifying a second symbol combination by a symbol at the second portion of the mechanical reel in the visible state in the transparent area of the second display screen and a symbol when displayed in the non-transparent area of the second display screen; (d-1) determining an active symbol combination for awarding the payout to the player by the first symbol combination and the second symbol combination; and (d-2) awarding a payout to a player based on one of the first symbol combination and the second symbol combination.

### BRIEF DESCRIPTION OF THE DRAWINGS

FIG. 1 is a view showing characteristics of a slot machine according to one embodiment of the present invention;

FIG. 2 is a perspective view of the slot machine;

FIG. 3 is a schematic view showing symbol columns drawn on each of reels;

FIG. 4 is a block diagram schematically showing an internal construction of entire slot machine;

FIG. 5 is a block diagram schematically showing an internal construction of a sub control board;

FIG. 6 is a payout table showing winning combinations and payout amounts thereof when a slot game is conducted by using each of reels;

FIG. 7 is a view showing an image example displayed on a liquid crystal panel;

FIG. 8 is a view showing an image example displayed on the liquid crystal panel;

FIG. 9 is a flowchart of a main control program;

FIG. 10 is a flowchart of a main game process program;

FIG. 11 is a diagram showing relation of random number values and position of mechanical reel;

FIG. 12 is a diagram showing relation of random number values and active screens.

### DETAILED DESCRIPTION

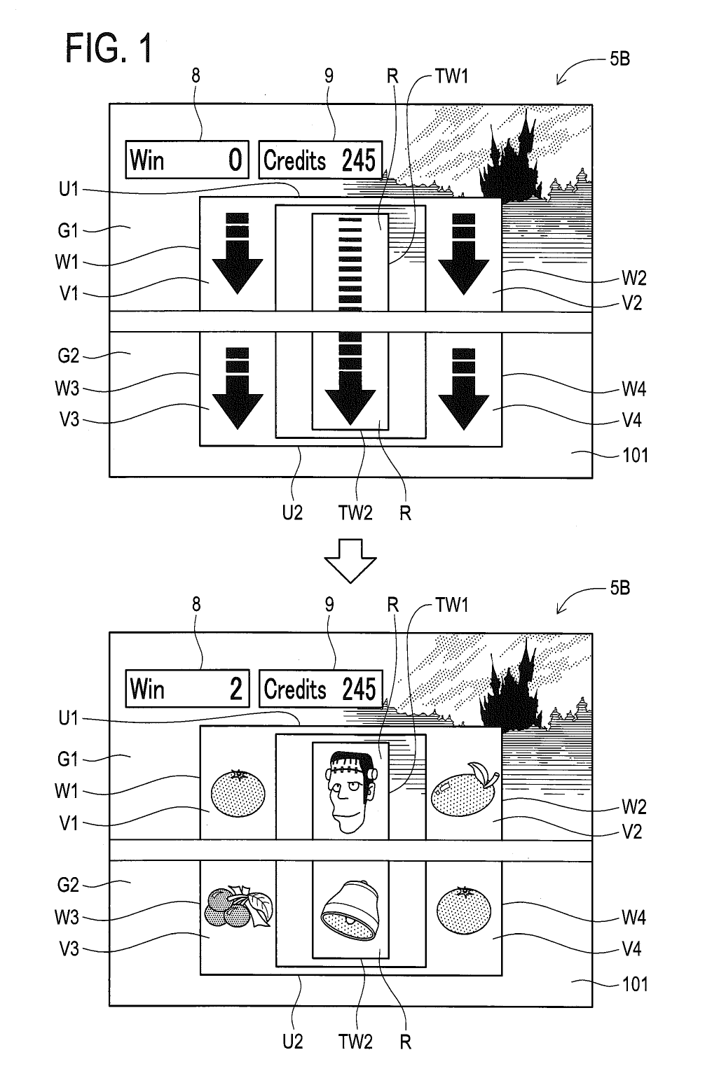

In the following, embodiments of the present invention are described with reference to the drawings. FIG. 1 is a view showing characteristics of a slot machine according to one embodiment of the present invention.

Games to be played in the slot machine according to this embodiment consist of slot games that are simultaneously executed on two display screens.

As shown in FIG. 1, in the slot machine according to this embodiment, a touch panel 101 is provided on a liquid crystal panel 5B consisting of a well-known transparent liquid crystal display. The liquid crystal panel 5B is also divided into a first display screen G1 and a second display screen G2.

In the first display screen G1 that is an upper half of the liquid crystal panel 5B, two respective display windows W1, W2 that are kept in a non-transparent state are provided so as to sandwich between sides of one display window TW1 that is kept in a transparent state. In the upper part of the one display window TW1, the two respective display windows W1, W2 are connected and displayed by a connection window U1 that is kept in a non-transparent state. Further, a payout amount display portion 8 and a credit amount display portion 9 are provided. At the same time, in the second display screen G2 that is a lower half of the liquid crystal panel 5B, two respective display windows W3, W4 that are kept in a non-transparent state are provided so as to sandwich between sides of one display window TW2. In the lower part of the one display window TW2, the two respective display windows W3, W4 are connected and displayed by a connection window U2 that is kept in a non-transparent state.

Subsequently, when a slot game starts, as shown in the upper stage of FIG. 1, two lines of the respective video reels V1, V2 are displayed in a rotating manner, respectively, in the two respective display windows W1 and W2 in a non-transparent state of the first display screen G1. Further, two lines of the respective video reels V3, V4 are displayed in a rotating manner, respectively, in the two respective display windows W3, W4 in a non-transparent state of the second display screen G2.

Further, rotation of one mechanical reel R can be visually checked through the display window TW1 in a transparent state in the first display screen G1 and the display window TW2 in a transparent state in the second display screen G2. In this respect, rotation of the upper half of the mechanical reel R can be visually checked in the display window TW1 in a transparent state in the first display screen G1, and that of the lower half of the mechanical reel R can be visually checked in the display window TW2 in a transparent state in the second display screen G2.

Thereafter, if a predetermined period of time has elapsed, as shown in the lower stage of FIG. 1, the two lines of respective video reels V1, V2 are displayed in a stopped manner, respectively, in the two respective display windows W1, W2 in a non-transparent state on the first display screen G1, whereby one symbol is rearranged, respectively. Further, the two lines of respective video reels V3, V4 are displayed in a stopped manner, respectively, in the two respective display windows W3, W4 in a non-transparent state on the second display screen G2, so that one symbol is rearranged, respectively.

Further, stopping of the one mechanical reel R can be visually checked through the display window TW1 in a transparent state in the first display screen G1 and the display window TW2 in a transparent state in the second display screen G2. With this configuration, one symbol of the mechanical reel R is rearranged in the display window TW1 on the first display screen G1, and one symbol of the mechanical reel R is rearranged in the display window TW2 on the second display screen G2.

Subsequently, if the first display screen G1 is considered an active screen, and when a symbol combination consisting of three symbols rearranged in the respective display windows W1, TW2, W2 matches any of winning combinations, a payout amount corresponding to the winning combination is displayed in the payout amount display portion 8. Further, if the second display screen G2 is considered an active screen, and when a symbol combination consisting of three symbols rearranged in the respective display windows W3, TW2, W4 matches any of winning combinations, a payout amount corresponding to the winning combination is displayed in the payout amount display portion 8.

Alternatively, if the first display screen G1 and the second display screen G2 are both considered an active screen, a total of payout amounts corresponding to the respective winning combinations is displayed in the payout amount display portion 8 when symbol combinations of the both match any of the winning combinations; a payout amount corresponding to the winning combination is displayed in the payout amount display portion 8 when only the symbol combination consisting of the three symbols rearranged in the respective display windows W1, TW1, W2 on the first display screen G1 matches any of the winning combinations; a payout amount corresponding to the winning combination is displayed in the payout amount display portion 8 when only the symbol combination consisting of the three symbols rearranged in the respective display windows W3, TW2, W4 on the second display screen G2 matches any of the winning combinations.

This constitutes a unit game of a slot game to be executed simultaneously on the two display screens G1, G2. Then, a payout amount displayed in the payout amount display portion 8 is added to and displayed in the credit amount display portion 9 when the unit game ends.

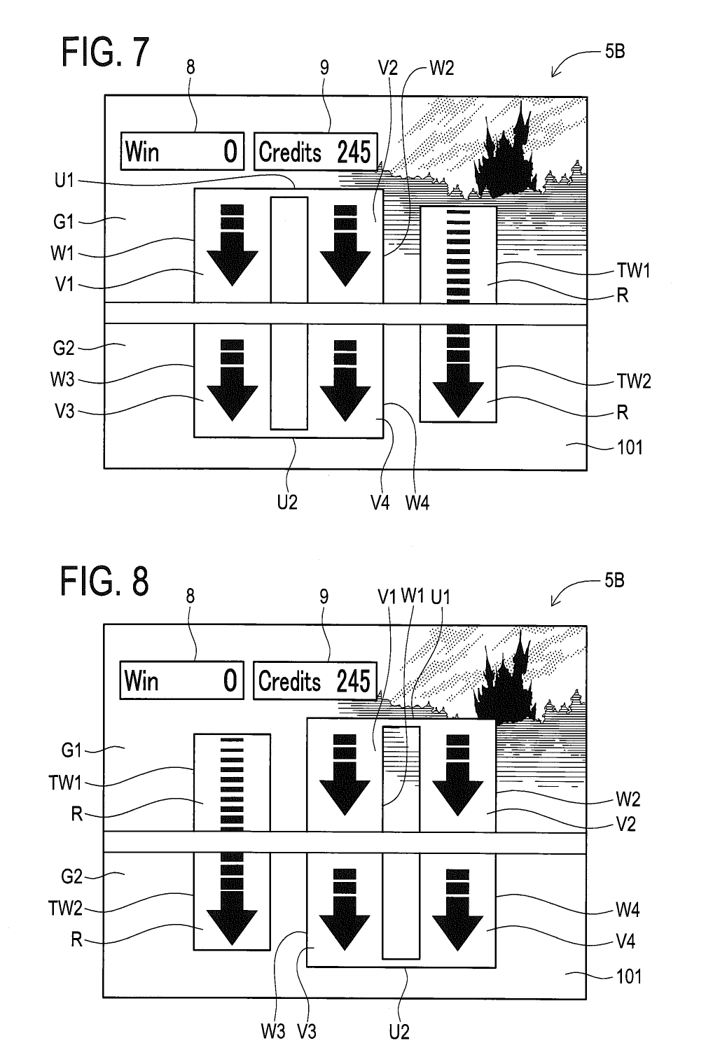

Additionally, in the slot machine according to this embodiment, before a slot game starts, the mechanical reel R may rectilinearly move to the right or the left, and respective positions of the respective display windows W1, TW1, W2 on the first display screen G1 and the respective display windows W3, TW2, and W4 on the second display screen G2 are changed according to the position of the mechanical reel R following the rectilinear movement (refer to FIG. 7 and FIG. 8).

Hereinafter, the embodiment embodying the present invention will be described in detail with reference to the drawings.

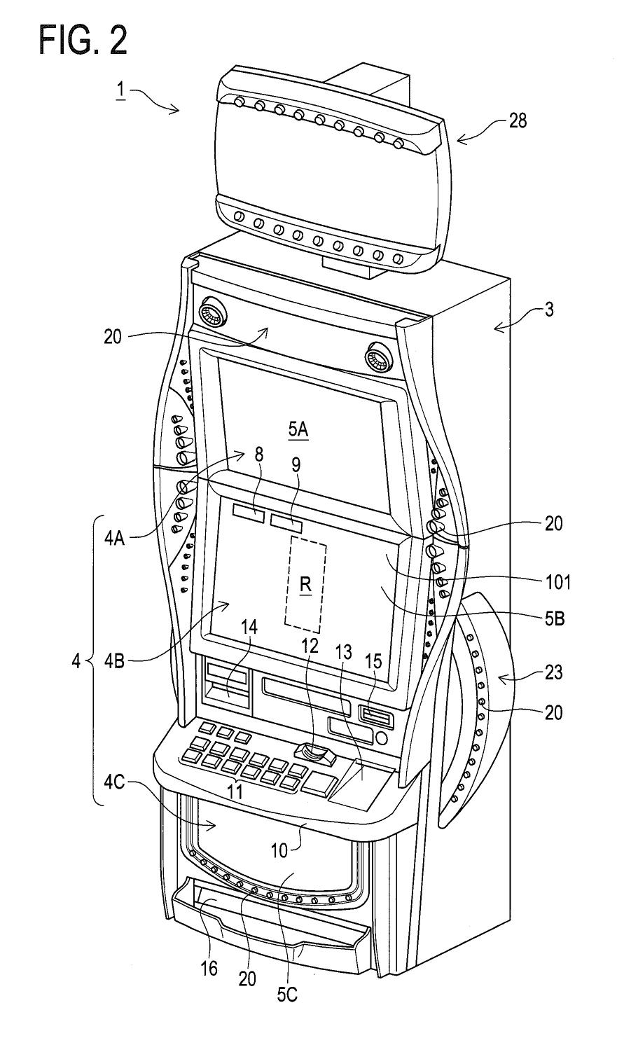

First, an outline construction of the slot machine 1 according to the embodiment is described with reference to FIG. 2. FIG. 2 is a perspective view of the slot machine 1 according to the embodiment.

As shown in FIG. 2, the slot machine 1 is an upright type gaming machine arranged in the game arcade such as casino, in order to execute predetermined game modes, such slot machine includes a cabinet 3 in which electronic and mechanical components are installed. For example, as a display portion 4 to display information concerning the game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, the effect image, the introduction of the game content, and the rule explanation of the game are displayed. The lower display portion 4C is arranged below the middle variable display portion 4B, and includes a plastic panel 5C on which the images are printed, and the plastic panel 5C is lightened by the backlights.

The middle variable display portion 4B, which is used to display the execution state of the game, includes the transparent liquid crystal panel 5B which is fixed at the front door of the cabinet 3. Through the liquid crystal panel 5B, the symbols of the mechanical reel R arranged inside the cabinet 3, may be visible to a player. On the upper position of the middle variable display portion 4B, the payout amount display portion 8 and the credit amount display portion 9 are arranged on the liquid crystal panel 5B. Also the upper portion of the middle variable display portion 4B, is related to the back side, thereby the player may play games in a cozy posture.

Now, a description is made on images related to a game displayed on the liquid crystal panel 5B. FIG. 1 above is a view showing the contents displayed on the liquid crystal panel 5B, by way of example. As shown in FIG. 1, during the game, the liquid crystal panel 5B is divided into the first display screen G1 and the second display screen G2. Respective display windows W1, W2 on the first display screen and respective display windows W3, W4 on the second display screen G2 are kept in a non-transparent state, which thereby clearly shows rotational display/stop display of symbols drawn on the reel bands of the respective video reels V1, V2, V3 and V4. Further, the display window TW1 on the first display screen G1 and the display window TW2 on the second display screen G2 are kept in a transparent state, which thereby enables players to visually check the symbols drawn on the reel band of the mechanical reel R.

The lower stage of FIG. 1 shows the state in which the symbols drawn on the reel bands of the respective video reels V1, V2, V3, and V4 are arranged or rearranged in the respective display windows W1, W2 on the first display screen G1 and the respective display widows W3, W4 on the second display screen G2, while the symbols drawn on the reel band of the mechanical reel R are arranged or rearranged through the display window TW1 on the first display screen G1 and the display window TW2 on the second display screen G2.

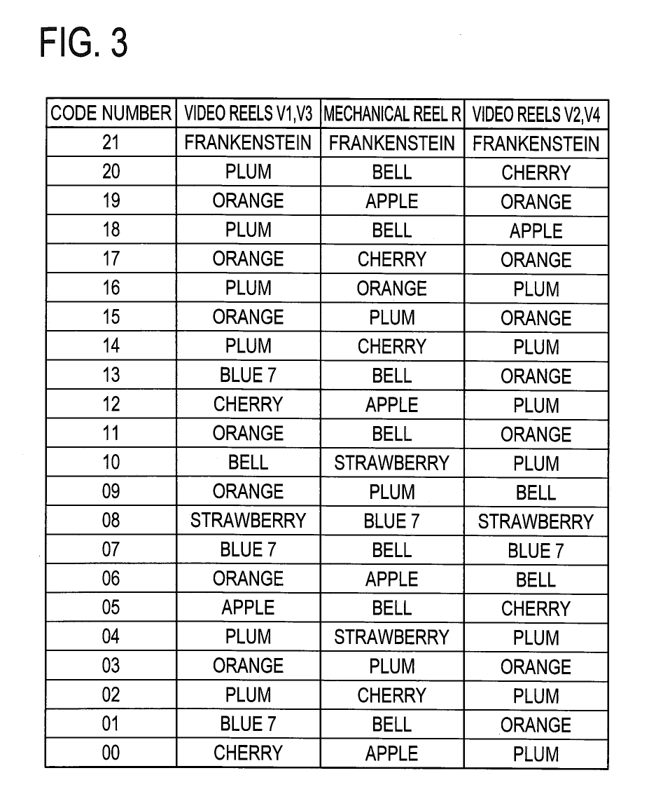

The upper stage of FIG. 1 shows the state in which the symbols drawn on the reel bands of the respective video reels V1, V2, V3, and V4 are displayed in a rotating manner in the respective display windows W1, W2 on the first display screen and the respective display windows W3, W4 on the second display screen G2, while the symbols drawn on the reel band of the mechanical reel R are displayed in a rotating manner through the display window TW1 on the first display screen G1 and the display window TW2 on the second display screen G2. Further, symbol sequences consisting of 22 symbols are drawn on the reel bands of the respective reels V1, V2, V3, V4 and R, respectively (refer to FIG. 3).

Also, in front of the liquid crystal panel 5B, the touch panel 101 is arranged, and a player may input his/her various instructions by operating the touch panel 101.

Further, the payout amount display portion 8 and the credit amount display portion 9 are provided in (the first display screen G1 that is the upper half of) the liquid crystal panel 5B. The payout amount display portion 8 displays payout amounts are awarded to a player in a slot game. The credit amount display portion 9 displays credit amounts owned by a player.

Thus, on the liquid crystal panel 5B during a slot game, the respective display windows W1, W2 on the first display screen G1 and the respective display windows W3, W4 on the second display screen G2 are kept in a non-transparent state, where each one of symbols drawn on the reel bands of the respective video reels V1, V2, V3 and V4 is arranged, respectively. Further, the display window TW1 on the first display screen G1 and the display window TW2 on the second display screen G2 are kept in a transparent state, where each one of symbols drawn on the reel band of the mechanical reel R is arranged through the respective display windows TW1, TW2.

With this configuration, on the first display screen G1 that is the upper half of the liquid crystal panel 5B, three symbols drawn on the reel bands of the respective reels V1, R, and V2 are arranged in the respective display windows W1, TW1 and W2 respectively. Further, on the second display screen G2 that is the lower half of the liquid crystal panel 5B, three symbols drawn on the reel bands of the respective reels V3, R, and V4 are arranged in the respective display windows W3, TW2, and W4 respectively.

Additionally, as described above, the mechanical reel R may rectilinearly move to the right or the left before a slot game starts. In FIG. 1, the mechanical reel R and the respective display windows TW1, TW2 through which the mechanical reel R can be seen are located in the center of the liquid crystal panel 5B. In this respect, if the mechanical reel R rectilinearly moves to the right, the liquid crystal panel 5B will be as shown in FIG. 7. Compared with FIG. 1 above, positions of the display window TW1 and the display window W2 are switched on the first display screen G1, and positions of the display window TW2 and the display window W4 are switched on the second display screen G2. Further, if the mechanical reel R rectilinearly moves to the left, the liquid crystal panel 5B will be as shown in FIG. 8. Compared with FIG. 1 above, positions of the display window TW1 and the display window W1 are switched on the first display screen G1, and positions of the display window TW2 and the display window W3 are switched on the second display screen G2. With this configuration, even when the mechanical reel R rectilinearly moves, symbols drawn on the reel band of the mechanical reel R after the rectilinear movement can be checked visually through the display window TW1 in a transparent state on the first display screen G1 and the display window TW2 in a transparent state on the second display screen G2.

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button, are arranged as the operation portion to execute a game. On the operation table 10, a coin insertion slot 12 and a bill insertion slot 13 are arranged. Also between the operation table 10 and the middle variable display portion 4B, a ticket printer 14 and a card reader 15 are arranged. At the lowest position of the cabinet 3, a coin tray 16 is also arranged.

In the slot machine 1 of the embodiment, the gaming medium may be coin, bill, or electronic value (credit). Here, the gaming medium may be others as well, such as medal, token, electronic money, or ticket.

On the cabinet 3 of the slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

Next, the symbols drawn on the reel band of each reel V1, V2, V3, V4 and R will be explained with reference to FIG. 3. These symbols are scrolled and rearranged in each display window W1, W2, W3, W4, TW1 and TW2 on each display screen G1 and G2 of the liquid crystal panel 5B during a slot game. FIG. 3 is a schematic view schematically showing symbol columns drawn on the reel band of each reel V1, V2, V3, V4 and R.

On the reel band of each reel V1, V2, V3, V4 and R twenty-two symbols are arranged respectively. Each symbol column is constructed from the symbols including [FRANKENSTEIN], [BLUE 7], [BELL], [APPLE], [CHERRY], [STRAWBERRY], [PLUM] and [ORANGE]. And the symbols of the predetermined types are arranged in a predetermined sequence.

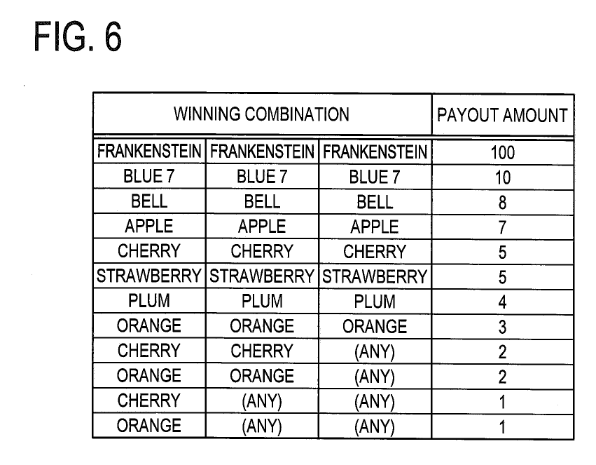

Here, when three symbols of [FRANKENSTEIN], [BLUE 7], [BELL], [APPLE], [CHERRY], [STRAWBERRY], [PLUM] and [ORANGE] are rearranged In the display windows W1, TW1 and W2 on the first display screen G1 or in the display windows W3, TW2 and W4 on the second display screen G2, a predetermined payout amount is awarded to a player (refer to FIG. 6). Also, regarding the symbols of [CHERRY] and [ORANGE], even when one or two [CHERRY] or [ORANGE] is/are rearranged in the display windows W1, TW1 and W2 on the first display screen G1 or in the display windows W3, TW2 and W4 on the second display screen G2, a predetermined payout amount corresponding to the number of the symbols is awarded to a player (refer to FIG. 6).

To each symbol consisting each symbol column shown in FIG. 3, a symbol number is allocated from top to down in sequence.

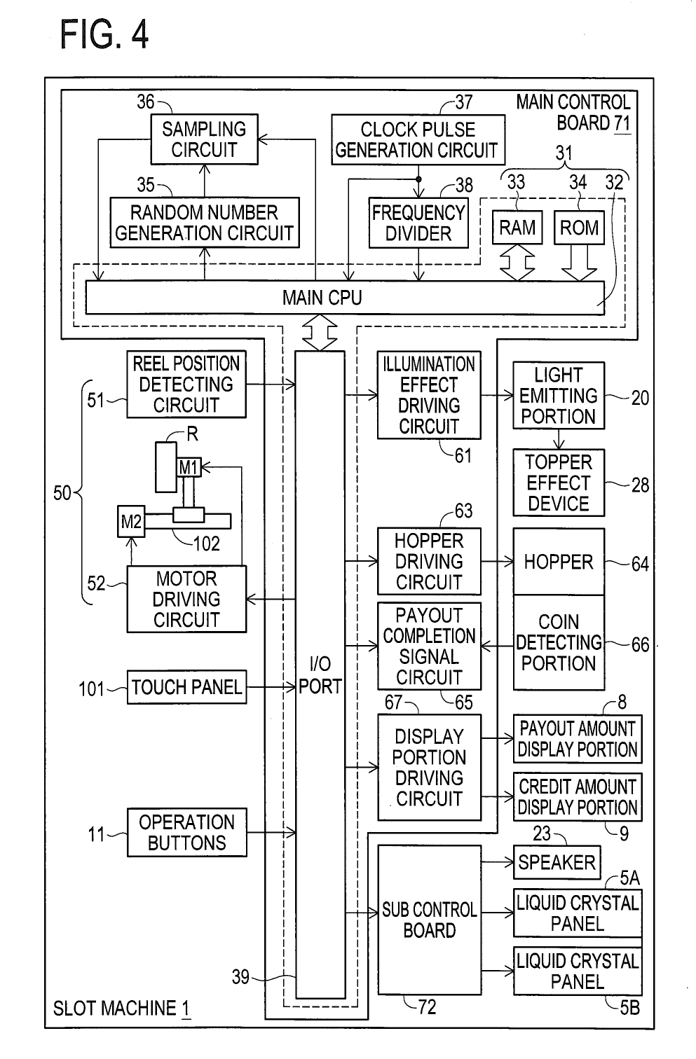

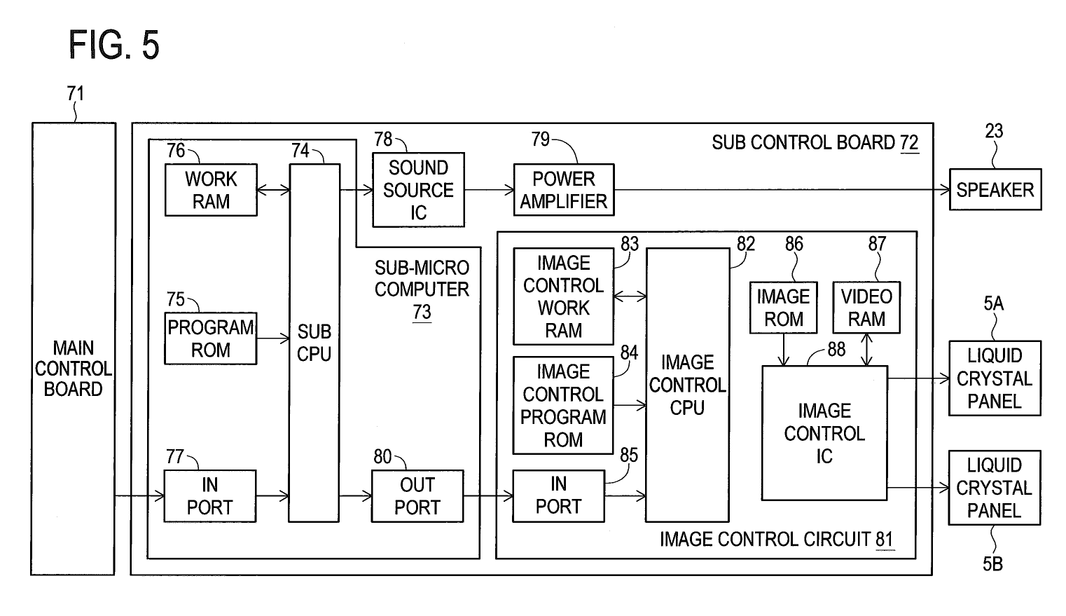

Next, the internal construction of the above slot machine 1 will be explained with reference to FIG. 4 and FIG. 5.

FIG. 4 is a block diagram schematically showing the internal construction of entire slot machine 1. As shown in FIG. 4, the slot machine 1 includes a plurality of construction elements such as the main control board 71, in which a microcomputer 31 is included. The main control board 71 is constructed from the microcomputer 31, a random number generation circuit 35, a sampling circuit 36, a clock pulse generation circuit 37 and a frequency divider 38. The main control board 71 also includes an illumination effect driving circuit 61, a hopper driving circuit 63, a payout completion signal circuit 65 and a display portion driving circuit 67.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code number of each reel V1, V2, V3, V4 and R and the symbol numbers are stored in the RAM 33. And the programs executed by the main CPU 32 and the permanent data are stored in the ROM 34.

Especially, the programs stored in the ROM 34 include the game programs and the game system programs (abbreviated as “the game programs and the like” hereinafter). And a lottery program mentioned below is also included in the game programs.

The lottery program is a program used to determine the code number of each reel V1, V2, V3, V4 and R which corresponds to each symbol rearranged in the display windows W1, TW1 and W2 on the first display screen G1 or in the display windows W3, TW2 and W4 on the second display screen G2 of the liquid crystal panel 5B. In the lottery program, it is included symbol weighing data corresponding to each of plural kinds of payout rates (for example, 80%, 84% and 88%). The symbol weighing data are the data indicating correlation between the code number of each reel and one or plural random numbers belonging to a predetermined number range (0 to 255), every each of the reels V1, V2, V3, V4 and R. In other words, each of the code number of one reel is associated with one or more random numbers corresponding to the payout rate. The random number is extracted by the lottery program, and the symbol specified finally by the random number is rearranged in the display windows W1, TW1 and W2 on the first display screen G1 or in the display windows W3, TW2 and W4 on the second display screen G2 of the liquid crystal panel 5B.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

And to the main control board 71, a reel driving unit 50 is connected. The reel driving unit 50 includes a reel position detection circuit 51 which detects the positions of the mechanical reel R and a motor driving circuit 52 which inputs driving signals to a motor M1 which are used to rotate the mechanical reel R. The motors M1 is operated based on driving signals input from the motor driving circuit 52, and rotate the mechanical reel R, and stop the mechanical reel R at a desired position.

Further, this reel driving unit 50 has a slide unit 102 for rectilinearly moving the mechanical reel R. A rail for the slide unit 102 is laid in a direction orthogonal to the reel rotating direction of the mechanical reel R. Further, a motor M2 that is a drive source of the slide unit 102 is connected to the motor driving circuit 52. The motors M2 is operated based on driving signals input from the motor driving circuit 52, and causes the mechanical reel R to rectilinearly move to any of the center, the right or the left.

Furthermore, the touch panel 101 is connected to the main control board 71. The touch panel 101 is arranged in front of the liquid crystal panel 5B, and specifies the coordinate position of the portion touched by a player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include the spin button, the collecting button and the BET button and the like. The signals corresponding to the pressing of these buttons are input to the main CPU 32 through I/O port 39.

The effect signals which are used to conduct illumination effect are output to the above-mentioned light emitting portion 20 and the topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit amount display portion 9 is controlled by the display portion driving circuit 67.

Furthermore, a sub control board 72 is connected to the main control board 71. As shown in FIG. 5, commands from the main control board 71 are input to the sub control board 72. The display control on the liquid crystal panel 5A of the upper display portion 4A and the liquid crystal panel 5B of the variable display portion 4B, and the sound output control on the speaker 23 is executed by the sub control board 72. The sub control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation device and a sampling circuit are not included in the sub-control board 72, the sub-control board 72 is constructed so as to execute random number sampling according to the operation programs thereof The control programs executed by the sub CPU 74 are stored in the program ROM 75. The work RAM 76 is constructed as a temporary storing device when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing device when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. Thus, it stores the dot data on symbols drawn on the reel band of the each video reel V1, V2, V3 and V4. The video RAM 87 runs as a temporary storing device when the images are formed by the image control IC 88.

Further, based on control signals from the main CPU 32, the image control circuit 81 performs display control of rotational display/stop display of the video reels V1, V2, V3 and V4 in the respective display windows W1, W2 on the first display screen G1 or the respective display windows W3, W4 on the second display screen G2. Based on control signals from the main CPU 32, the image control circuit 81 also performs display control on position changing of the respective display windows W1, TW1 and W2 on the first display screen G1 or the respective display windows W3, TW2 and W4 on the second display screen G2.

Next, winning combinations and the payout amounts corresponding to the winning combinations will be explained with reference to FIG. 6, wherein the winning combinations are the symbol combinations when a slot game is executed by using each of the reels V1, V2, V3, V4 and R in the slot machine 1 according to the embodiment. FIG. 6 is a payout table in which the winning combinations and the payout amounts corresponding to the winning combinations are shown when a slot game is executed by using each of the reels V1, V2, V3, V4 and R.

Here, the payout amount shown in FIG. 6 indicates the payout amount when the bet number is “1”. Therefore, when the bet number is “1”, the payout amount shown in FIG. 6 is paid out, and when the bet number is more than “2”, the payout amount obtained by multiplying the payout amount shown in FIG. 6 with the bet number is paid out.

Thereby, when three symbols of [FRANKENSTEIN] are rearranged in the respective display windows W1, TW1 and W2 on the first display screen G1 or in the respective display windows W3, TW2 and W4 on the second display screen G2, the payout amount obtained by multiplying 100 credits with the bet number is paid out.

When three symbols of [BLUE 7] are rearranged in the respective display windows W1, TW1 and W2 on the first display screen G1 or in the respective display windows W3, TW2 and W4 on the second display screen G2, the payout amount obtained by multiplying 10 credits with the bet number is paid out.

When three symbols of [BELL] are rearranged in the respective display windows W1, TW1 and W2 on the first display screen G1 or in the respective display windows W3, TW2 and W4 on the second display screen G2, the payout amount obtained by multiplying 8 credits with the bet number is paid out.

The payout amount corresponding to each winning combination shown in FIG. 6, are set as the same in the above. However, when a symbol combination constructed from the symbols rearranged in the respective display windows W1, TW1 and W2 on the first display screen G1 or in the respective display windows W3, TW2 and W4 on the second display screen G2, is not any of the winning combinations shown in FIG. 6, the symbol combination is not a winning combination. Therefore, no credits may be paid out.

As mentioned above, in the slot machine 1 according to the embodiment, a slot game is executed.

In other words, in a slot game, the slot game is executed by rearranging the symbol combination specified by each reel V1, V2, V3, V4 and R in the respective display windows W1, TW1 and W2 on the first display screen G1 or in the respective display windows W3, TW2 and W4 on the second display screen G2. In the slot game, firstly, a part of symbol column (one symbol) drawn on the reel band of each reel V1, V2, V3, V4 and R (shown in FIG. 3), is arranged on the respective display screen G1 and G2 through the respective non-transparent display windows W1, W2, W3 and W4 and respective transparent display windows TW1 and TW2 (refer to the lower stage of FIG. 1). Here, after a player sets a bet number by pressing the BET button among the operation buttons 11, if the player presses the spin button, each of the reels V1, V2, V3, V4 and R rotates, the symbol column drawn on the reel band of each reel V1, V2, V3, V4 and R shown in FIG. 3, is scrolled from up to down on the respective display screen G1 and G2 of the liquid crystal panel 5B through the respective non-transparent display windows W1, W2, W3 and W4 and respective transparent display windows TW1 and TW2 (refer to the upper stage of FIG. 1).

After a predetermined time, each reel V1, V2, V3, V4 and R stops automatically, a part of the symbol column (one symbol) drawn on the reel band of each reel V1, V2, V3, V4 and R (shown in FIG. 3), is arranged on the respective display screen G1 and G2 through the respective non-transparent display windows W1, W2, W3 and W4 and respective transparent display windows TW1 and TW2 (refer to the lower stage of FIG. 1). On the other hand, each winning combination based on each symbol combination is determined beforehand (refer to FIG. 6). When the symbol combination constructed from the three symbols rearranged in the respective display windows W1, TW1 and W2 on the first display screen G1 or in the respective display windows W3, TW2 and W4 on the second display screen G2, realizes a winning combination, the payout amount obtained by multiplying the bet number with the payout amount corresponding to the realized winning combination is awarded to the player.

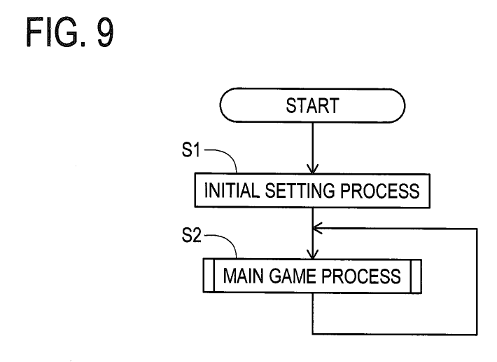

Next, the main control program executed in the slot machine 1 according to the embodiment will be explained with reference to figures. FIG. 9 is a flowchart of the main control program.

First, when a power switch is pressed, the microcomputer 31 is started to operate, an initialization is executed by the microcomputer 31 in step (abbreviated as “S”) 1. In an initialization process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initialization process, the verification process to each program is executed by the main CPU 32. Further, while the initial setting process is being executed, the main CPU 32 sets the position of the mechanical reel R in the center.

And in S2, the main CPU 32 reads out the game programs and the like from the RAM 33, and executes the programs in sequence so as to conduct a main game process. The game is executed in the slot machine 1 according to the embodiment by executing the main game process. And the main game process is repeated when the power is supplied to the slot machine 1.

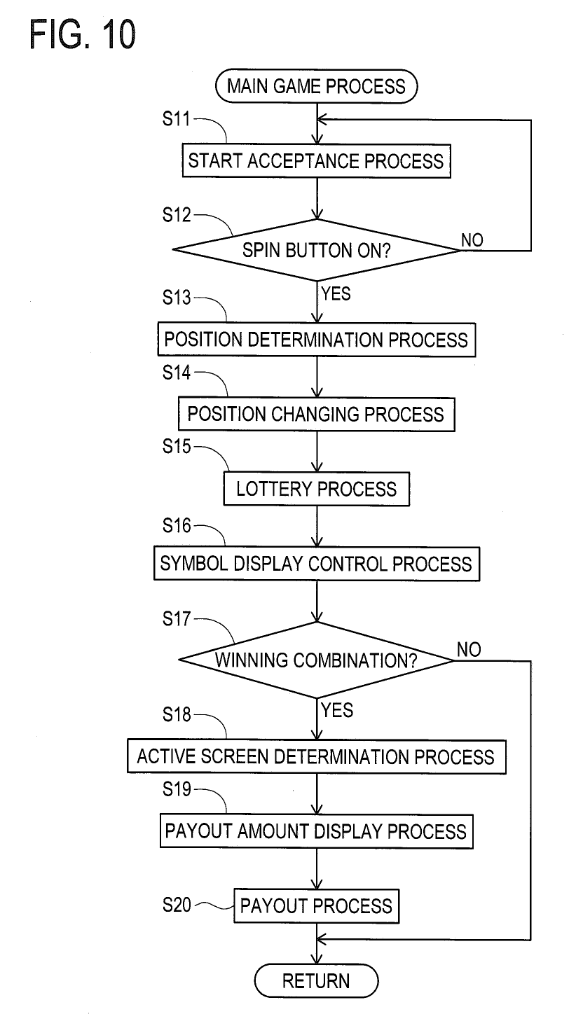

Next, the sub process of the main game process in S2 will be explained with reference to FIG. 10. FIG. 10 is a flowchart of a main game process program in the slot machine 1 according to the embodiment. Also, each program shown in the flowchart of FIG. 10 is stored in the ROM 34 or the RAM 33 of the slot machine 1, and is executed by the main CPU 32.

First, as shown in FIG. 10, a start acceptance process is executed by the main CPU 32 in S11. At this time, in the start acceptance process, the insertion of the coins or the bet operation using the BET button among the operation buttons 11 is executed by a player. Further, by transmitting control signals to the sub control board 72, the main CPU 32 divides the liquid crystal panel 5B into the first display screen G1 and the second display screen G2, and shifts or maintains the respective display windows TW1, TW2 located in the center therebetween into or in a transparent state and the respective display windows W1, W2, W3, and W4 located on both sides of the respective display windows TW1, TW2 into or in a non-transparent state.

And then, it is determined by the main CPU 32 whether the spin button among the operation buttons 11 is pressed in S12. It is determined based on the input signals corresponding to the button pressing of the operation button 11 to the main CPU 32. Here, when the spin button among the operation buttons 11 is not pressed (S12: NO), the game returns to the start acceptance process again. Thereby, it is possible to change the bet number and the like. On the other hand, when the spin button among the operation buttons 11 is pressed (S12: YES), the bet number set based on the above bet operation is reduced from the credits owned by the player at that time, and is stored in the RAM 33 as bet information. And the credit amount after reduction is also stored in the RAM 33 as the bet information.

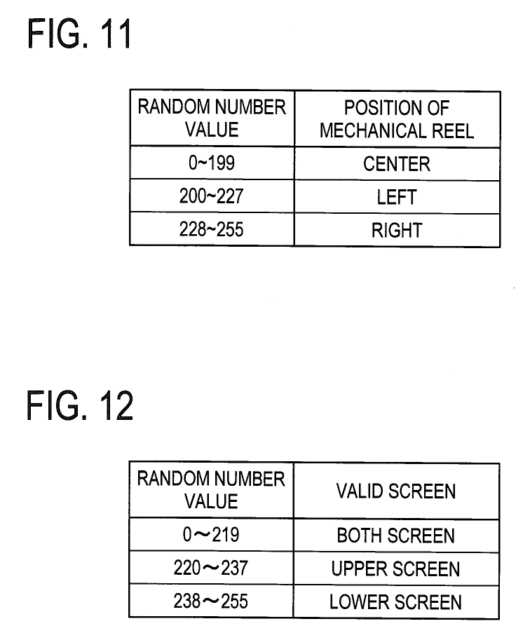

Subsequently, when proceeding to S13, the main CPU 32 executes a position determination process. To be specific, the main CPU 32 selects one random number from the range of numeric values of “0 to 255”. As shown in the table of FIG. 11, this random number value corresponds to the position of the mechanical reel R. According to the table shown in FIG. 11, if a random number is any value in the range of “0” to “199”, the corresponding position of the mechanical reel R is the “center”. If a random number is any value in the range of “200” to “227”, the corresponding position of the mechanical reel R is the “left”. If a random number is any value in the range of “228” to “255”, the position of the mechanical reel R is the “right”. Then, after the data on the position of the mechanical reel R is stored in the RAM 33 based on the selected one random number and the table shown in FIG. 11, the game proceeds to S14.

Subsequently, when proceeding to S14, the main CPU 32 executes a position changing process. To be specific, the main CPU 32 causes the motor driving circuit 52 to drive the motor M2 and rectilinearly moves the mechanical reel R. This moves the mechanical reel R to the position determined in S13 described above. Further, by transmitting control signals to the sub control board 72, the main CPU 32 changes respective positions of the respective display windows W1, TW1, and W2 on the first display screen G1 and the respective display windows W3, TW2 and W4 on the second display screen G2, according to the position of the mechanical reel R following rectilinear movement (refer to FIG. 7 and FIG. 8).

In S15 a lottery process in a base game is executed by the main CPU 32. To be specific, when the lottery program included in the game programs is executed by the main CPU 32, the random number corresponding to each reel V1, V2, V3 and V4 respectively is selected from a range of 0 to 255. And with reference to the symbol weighing data corresponding to the payout rate setting data, based on the five random numbers, the code number of each reel V1, R, V2, V3 and V4 is determined. The determined code number of each reel V1, R, V2, V3 and V4 is stored in the RAM 33 by the main CPU 32, and the game proceeds to S16.

Now, code number of each reel V1, R, V2, V3 and V4 correspond to symbol numbers (symbol numbers in FIG. 3) to be rearranged in the respective display windows W1, TW1 and W2 on the first display screen G1 and the respective display windows W3, W4 on the second display screen G2 of the liquid crystal panel 5B. Further, as rotation/stop of the upper/lower half of one mechanical reel R can be checked visually in the display window TW1 on the first display screen G1 and the display window TW2 on the second display screen G2, due to a relative positional relationship, a symbol number (the symbol number in FIG. 3) to be rearranged in the display window TW2 on the second display screen G2 is also determined if a symbol number (the symbol number in FIG. 3) to be rearranged in the display window TW1 on the first display screen G1 is determined. Thus, when the main CPU 32 determines code number of each reel V1, R, V2, V3 and V4, a combination of symbols in the game is determined. For example, when “21”, “21”, “21”, “21”, and “21” are determined as the code number of each reel V1, R, V2, V3 and V4, the main CPU 32 determines a combination of symbols consisting of three [FRANKENSTEIN] symbols for a combination of symbols to be rearranged in the respective display windows W1, TW1, and W2 on the first display screen G1, and a combination of symbols consisting of [FRANKENSTEIN], [BELL], and [FRANKENSTEIN] for a combination of symbols to be rearranged in the respective display windows W3, TW2, and W4 on the second display screen G2 (refer to FIG. 3). As such, as the code number of each reel V1, R, V2, V3 and V4 are determined, lottery of a symbol combination related to the slot game is performed.

When the game proceeds to S16, a symbol display control process is executed by the main CPU 32. To be specific, first, a reel rotation process is executed by the main CPU 32. In other words, the motor M1 is driven by the main CPU 32 through the motor driving circuit 52, so as to rotate the mechanical reel R. And then, the effect mode (the display mode of the images on the liquid crystal panel 5B and the sound output mode from the speaker 23) is determined by the main CPU 32, and the sub control board 72 is ordered to start the effect in a predetermined effect pattern. Further, control signals are transmitted to the sub control board 72 by the main CPU 32, so as to display each video reel V1, V2, V3 and V4 in a rotating manner. And then, when the predetermined stop timing to stop each reel V1, R, V2, V3 and V4 comes, a reel stop process is executed by the main CPU 32 through the motor driving circuit 52, thereby the mechanical reel R is stopped based on the code number stored in the RAM 33. And each video reel V1, V2, V3 and V4 is displayed in a stopping manner by control of the sub control board 72. Thereby, the symbol combination determined in above S13 is rearranged in the respective display windows W1, TW1 and W2 on the first display screen G1 of the liquid crystal panel 5B and in the respective display windows W3, TW2 and W4 on the second display screen G2 of the liquid crystal panel 5B.

And in the S17, it is determined by the main CPU 32 whether a winning combination is realized. The determination is made based on the code number of each reel V1, R, V2, V3 and V4 stored in the RAM 33. Here, when a winning combination is not realized (S17: NO), the program is executed again. On the other hand, when a winning combination is realized (S17: YES), the game proceeds to S18.

Subsequently, when proceeding to S18, the main CPU 32 executes an active screen determination process. To be specific, the main CPU 32 selects one random number from the range of numeric values of “0 to 255”. This random number value corresponds to an active display screen of the respective display screens G1, G2, as shown in the table of FIG. 12. According to the table of FIG. 12, if a random number is any value in the range from “0” to “219”, both the screens (i.e., the respective display screens G1, G2) are corresponding active screens. If a random number is any value in the range from “220” to “237”, the upper screen (i.e., the display screen G1) is a corresponding active screen. If a random number is any value in the range from “238” to “255”, the lower screen (i.e., the display screen G2) is a corresponding active screen. Then, after the data on the active display screen of the respective display screens G1, G2 is stored in the RAM 33 based on the selected one random number and the table shown in FIG. 12, the process proceeds to S19.

In S19, the main CPU 32 executes a payout amount display process. To be specific, first, the main CPU 32 calculates an amount to be obtained by multiplying the bet number with a total amount of a payout amount corresponding to a winning combination rearranged in the respective display windows W1, TW1 and W2 on the first display screen G1 and a payout amount corresponding to a winning combination rearranged in the respective display windows W3, W4 on the second display screen G2 of the liquid crystal panel 5B. This calculation is performed based on the bet information in the RAM 33 or the payout table in FIG. 6. However, based on the active display screen determined in S18 above, a winning combination of a display screen that is not active of the respective display screens G1, G2 is eliminated from this calculation. The calculated amount is stored as the payout information in the RAM 33. Then, by transmitting control signals to the display portion driving circuit 67, the main CPU 32 displays the payout information (the above calculated amount) stored in the RAM 33 in the payout amount display portion 8 of the liquid crystal panel 5B.

And when the game proceeds to S20, a payout process is executed by the main CPU 32. In the payout process, the payout amount obtained by the player in the slot game, is paid out to the player, based on the payout information stored in the RAM 33.

When the payout is executed, the credits which are stored in the RAM 33 as the payout information are added to the credits stored in the RAM 33 as credit information, and the added value is overwritten in the RAM 33 as the credit information. And then, control signals are transmitted to the display portion driving circuit 67 by the main CPU 32, the credits information stored in the RAM 33 (the added value in S20) is displayed on the credit amount display portion 9 of the liquid crystal panel 5B. At the same time, “0” is overwritten to the RAM 33 as the payout information, and by transmitting control signals to the display portion driving circuit 67, on the payout amount display portion 8 of the liquid crystal panel 5B, “0” is displayed.

In the payout process, the credits owned by the player at that time (1 credit equals to 1 coin) may be paid out by the coins corresponding to based on the pressing on the CASHOUT button among the operation buttons 11, or may also be paid out by a ticket with a bar code which is printed by the ticket printer 14.

As described above, in the slot machine 1 according to this embodiment, the liquid crystal panel 5B is divided into the first display screen G1 and the second display screen G2, wherein a slot game is executed that rearranges a certain combination of symbols by the respective reels V1, V2, V3, V4 and R, in the respective display windows W1, TW1, and W2 on the first display screen G1 and the respective display windows W3, TW2 and W4 on the second display screen G2. In this respect, the respective video reels V1, V2 rotationally displays/stops displaying, whereby symbols drawn on the reel bands of the respective video reels V1, V2 are rearranged one by one in the respective display windows W1, W2 in a non-transparent state on the first display screen G1. Further, the respective video reels V3, V4 rotationally displays/stops displaying, whereby symbols drawn on the reel bands of the respective video reels V3, V4 are rearranged one by one in the respective display windows W3, W4 in a non-transparent state on the second display screen G2. Furthermore, when one mechanical reel R rotates and stops, symbols drawn on the reel band of the mechanical reel R are rearranged one by one in the display window TW1 in a transparent state on the first display screen G1 and the display window TW2 in a transparent state on the second display screen G2 (refer to FIG. 1 above).

Therefore, the slot game that rearranges a certain combination of symbols in the respective display windows W1, TW1, and W2 on the first display screen and the slot game that rearranges a certain combination of symbols in the respective display windows W3, TW2, and W4 on the second display screen G2 are executed simultaneously. In these slot games, as rotation/stop of the one mechanical reel R influences rearrangement of the symbols in both the display window TW1 on the first display screen G1 and the display window TW2 on the second display window G2, they can be recognized as one game interlocked by the mechanical reel R.

Further, when a player is awarded with payout, a winning combination on an active display screen of the respective display screens G1, G2 is subject to the payout (S18, S19). Accordingly, as there are a number of cases such as the case in which a winning combination only on the first display screen G1 is subject to the payout, the case in which a winning combination only on the second display screen G2 is subject to the payout, and the case in which winning combinations on both the first display screen G1 and the second display screen G2 are subject to the payout (refer to FIG. 12), it is possible to diversify interlocking of these slot games.

Further, before a slot game starts, the mechanical reel R located in the center may rectilinearly move to the right or the left (S13, S14), and thus respective positions of the respective display windows W1, TW1, and W2 on the first display screen G1 and the respective display windows W3, TW2, and W4 on the second display screen G2 are changed according to the position of the mechanical reel R following the rectilinear movement (refer to S14, FIG. 7 and FIG. 8). Accordingly, it is possible to diversify games that are recognized as one by the mechanical reel R.

Additionally, the present invention is not limited to the embodiments described above, but various changes may be made without departing from its scope.

For example, the liquid crystal panel 5B may comprise two transparent liquid crystal panels, one transparent liquid crystal panel being a first display screen G1, and the other transparent liquid crystal panel being a second display screen G2.

Alternatively, an active display screen of the respective display screens G1, G2 may be determined based on bet number.

Alternatively, a slot game may be executed on the respective display screens G1, G2, by increasing the number of symbols to be rearranged in the respective display windows W1, TW1, W2 on the first display screen G1 or the respective display windows W3, TW2, W4 on the second display screen G2 in accordance with bet number, and by displaying a pay line that specifies combinations of symbols.

What is claimed is:

1. A slot machine comprising:
a mechanical reel for which a symbol is provided;
a first display screen putting a first portion of the mechanical reel into a visible state in a transparent area, while displaying a symbol in a non-transparent area;
a second display screen putting a second portion of the mechanical reel into a visible state in a transparent area, while displaying a symbol in a non-transparent area;
a transparent liquid crystal display provided with the first display screen and the second display screen; and
a processor controlling the mechanical reel and the transparent liquid crystal display, programmed to execute processes of:
(a) rotating and stopping the mechanical reel at each unit game, while rearranging a symbol displayed at least one of the first display screen and the second display screen at each unit game;
(b) identifying a first symbol combination by a symbol at the first portion of the mechanical reel in the visible state in the transparent area of the first display screen and a symbol when displayed in the non-transparent area of the first display screen;
(c) identifying a second symbol combination by a symbol at the second portion of the mechanical reel in the visible state in the transparent area of the second display screen and a symbol when displayed in the non-transparent area of the second display screen; and
(d) awarding a payout to a player based on one of the first symbol combination and the second symbol combination.

2. The slot machine of claim 1, further comprising:
a slide mechanism moving the mechanical reel in a direction perpendicular to a rotating direction of the mechanical reel through a control of the processor, wherein the processor is programmed, when executing the process (a), to execute processes of:
(a-1) making a determination on whether to move the mechanical reel or not; and
(a-2) when moving the mechanical reel by the determination, changing a position of the mechanical reel while shifting the transparent area and the non-transparent area of the first display screen and the second display screen in accordance with a changed position of the mechanical reel.

3. The slot machine of claim 1, wherein
the processor determines, when executing the process (d), an active symbol combination for awarding the payout to the player by the first symbol combination and the second symbol combination.

4. A slot machine comprising:
a mechanical reel for which a symbol is provided;
a first display screen putting a first portion of the mechanical reel into a visible state in a transparent area, while displaying a symbol in a non-transparent area;
a second display screen putting a second portion of the mechanical reel into a visible state in a transparent area, while displaying a symbol in a non-transparent area;
a transparent liquid crystal display provided with the first display screen and the second display screen;
a slide mechanism moving the mechanical reel in a direction perpendicular to a rotating direction of the mechanical reel; and
a processor controlling the mechanical reel, the transparent liquid crystal display and the slide mechanism, programmed to execute processes of:
(a-1) making a determination on whether to move the mechanical reel or not;
(a-2) when moving the mechanical reel by the determination, changing a position of the mechanical reel while shifting the transparent area and the non-transparent area of the first display screen and the second display screen in accordance with a changed position of the mechanical reel;
(a-3) rotating and stopping the mechanical reel at each unit game, while rearranging a symbol displayed at least one of the first display screen and the second display screen at each unit game;
(b) identifying a first symbol combination by a symbol at the first portion of the mechanical reel in the visible state in the transparent area of the first display screen and a symbol when displayed in the non-transparent area of the first display screen;
(c) identifying a second symbol combination by a symbol at the second portion of the mechanical reel in the visible state in the transparent area of the second display screen and a symbol when displayed in the non-transparent area of the second display screen;
(d-1) determining an active symbol combination for awarding the payout to the player by the first symbol combination and the second symbol combination; and
(d-2) awarding a payout to a player based on one of the first symbol combination and the second symbol combination.
